(19) United States
(12) Patent Application Publication
(10) Pub. No.: US 2020/0384957 A1
(43) Pub. Date: Dec. 10, 2020

(54) Wiperless Auto Windshield System for Applying Air Pressure to Clean the Windshield

(71) Applicant: Harold A. Reznick, Betheda, MD (US)

(72) Inventor: Harold A. Reznick, Bethesda, MD (US)

(73) Assignee: Harold A. Reznick, Bethesda, MD (US)

(21) Appl. No.: 16/434,944

(22) Filed: Jun. 7, 2019

(51) Int. Cl. B60S 1/54

(52) U.S. Cl. CPC B60S 1/54; B08B 5/02

(57) ABSTRACT

The present invention provides an improved system for cleaning the windshield of cars, trucks, and other vehicles without using wipers by supplying sufficient air pressure to air jets located around the windshield surface to clean it. The air pressure is supplied to the air jets from the vehicle's engine or manifold which supplies air into one or more regulated air canisters which apply sufficient air pressure to the air jets to clean the windshield. The system has an electric pump which is actuated to produce the needed air pressure to the canister. When the canister needs more air pressure, an air supply sensor and relief valve of the canister is closed off to allow the electric pump to supply additional air to fill the canister, so it can supply additional air to the air jets to clean the windshield surface without wipers.

### PRIOR APPLICATION

Applicant claims priority from provisional patent application No. 62/285,966 filed on Dec. 7, 2015.

### FIELD OF THE INVENTION

The present invention relates to a wiperless windshield system for cleaning the windshield of a car, truck or other vehicle using air pressure and no windshield wipers.

### BACKGROUND OF THE INVENTION

Present systems typically use windshield wipers to clean windshields of cars, trucks or other vehicles by applying water to the surface of the windshield. Such existing systems have drawbacks which include the need to constantly clean, repair and replace windshield wipers. A more efficient economical system is desirable and needed to avoid such drawbacks. The present invention provides such an improved system.

### DISCUSSION OF PRIOR ART

U.S. Pat. No. 7,040,328 discloses a system that does not use windshield wipers to clean the windshield. Instead it uses fluid to wash the windshield. Thus, this system still has the drawback of using fluid to clean the windshield.

U.S. Pat. No. 8,322,776 discloses a system that cleans the windshield with liquid and a gaseous fluid. Thus this system still has the drawback of using liquid to clean the windshield.

### OBJECTS OF THE INVENTION

It is an object of the present invention to provide an improved system for cleaning windshields without wipers by supplying sufficient air pressure to the windshield surface.

It is another object of the present invention to supply air pressure from the vehicle's engine or manifold into an air canister to maintain sufficient air pressure to clean the windshield.

It is another object of the present invention to activate an electric pump to produce the needed air pressure to the air jets to clean the windshield surface without wipers.

### SUMMARY OF THE INVENTION

The present invention provides an improved system for cleaning the windshield of cars, trucks, and other vehicles without using wipers by supplying sufficient air pressure to air jets located around the windshield surface to clean it. The air pressure is supplied to the air jets from the vehicle's engine or manifold which supplies air into one or more regulated air canisters which apply sufficient air pressure to the air jets to clean the windshield. The system has an electric pump which is actuated to produce the needed air pressure to the canister. When the canister needs more air pressure, an air supply sensor and relief valve of the canister is closed off to allow the electric pump to supply additional air to fill the canister, so it can supply additional air to the air jets to clean the windshield surface without wipers.

### BRIEF DESCRIPTION OF THE DRAWINGS

FIG. 1 shows a diagram of the system of the present invention, including the engine manifold, the air supply hose, the regulated air canister, the PSI sensor and relief valve, the electric pump, the air supply hose, and the air jets around the windshield; and

FIG. 2 shows a diagram of the windshield with the surrounding air jets.

### DETAILED DESCRIPTION OF THE PREFERRED EMBODIMENT

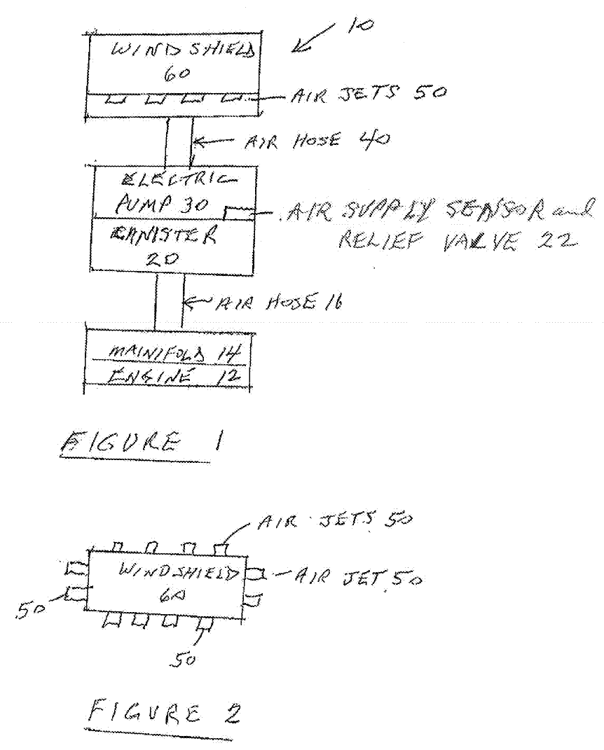

FIG. 1 shows the system 10 of the present invention, including the engine 12 having an air manifold 14 for supplying air pressure to the system 10. Air manifold 14 supplies air pressure to an air supply hose 16 which is connected to a regulated air supply canister 20, so that air pressure is supplied from supply hose 16 to canister 20.

Air canister 20 has a PSI sensor and air relief valve 22 for sensing when the canister has a decrease in air pressure and needs more air. When this occurs, an electric pump 30 actuates the air manifold 14 to supply additional air to air canister 20. When this occurs, the air supply from the air sensor and air relief valve 22 on air canister 20 is closed to allow the air canister 20 to receive and build up its air supply to the required pressure. Canister 20 and electric pump 30 may be one unit or housing with valve 22 in the same housing between canister 20 and pump 30.

An air supply hose 40 is connected on one end to the air canister 20, and the other end of hose 40 is connected to the air jets 50 for supplying the required air pressure to the windshield 60 for cleaning it with only the air jets 50 and without windshield wipers.

The preferred range of pressure is 120 to 150 PSI, but this may vary according to the number of air jets 50 that are used. The number of air jets 50 may range from 10 to 30 air jets, but this number may vary according to the size of the windshield. In addition, multiple air hoses 40 may be connected to the air jets 50 depending on the number of air jets.

### ADVANTAGES OF THE PRESENT INVENTION

It is an advantage of the present invention to provide an improved system for cleaning windshields without wipers by supplying sufficient air pressure to the windshield surface.

It is an advantage of the present invention to supply air pressure from the vehicle's engine or manifold into an air canister to maintain sufficient air pressure to clean the windshield.

It is an advantage of the present invention to activate an electric pump to produce the needed air pressure to the air jets to clean the windshield surface without wipers.

A latitude of modification, change and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1) An improved system (10) for cleaning the windshield (60) of a vehicle having air jets (50) below the windshield (60) and having no windshield wipers, comprising:
a) an engine air manifold (14) for supplying air pressure to said system (10);
b) said engine air manifold (14) is connected to a first air supply hose (16) for supplying air to said hose;
c) said first air supply hose (16) is connected to an air supply canister (20) for supplying air to said canister;
d) said air supply canister (20) having an air supply sensor and relief valve (22) for sensing when said air supply canister (20) has a drop in air pressure, and needs more air;
e) an electric pump (30) for actuating said air engine manifold (14) to supply additional air to said air supply canister (20);
f) said air supply sensor and relief valve (22) for closing off valve (22) to close off said air supply canister (20) when it is receiving air from said engine air manifold (14); and
g) a second air supply hose (40) is connected on one end to said electric pump (30) and to said air supply canister (20), and the other end of said second air supply hose (40) is connected to air jets (50) for supplying the required air pressure to said windshield (60) for cleaning it with only air jets (50) and without windshield wipers;
h) wherein said air canister (20) supplies an air pressure in the range of 100 to 150 PSI; and
i) wherein there are 10 to 30 air jets surrounding said windshield to clean it.
